(19) United States
(12) Patent Application Publication
(10) Pub. No.: US 2025/0213904 A1
(43) Pub. Date: Jul. 3, 2025

(54) SPRINKLER HEAD

(71) Applicant: SENJU SPRINKLER CO., LTD., Tokyo (JP)

(72) Inventors: Masaharu CHIBA, Tokyo (JP); Yoshiki SASAKI, Tokyo (JP); Kazuma ITO, Tokyo (JP)

(73) Assignee: SENJU SPRINKLER CO., LTD., Tokyo (JP)

(21) Appl. No.: 18/848,607

(22) PCT Filed: Apr. 4, 2022
(86) PCT No.: PCT/JP2022/017047

§ 371 Date: Sep. 19, 2024

(51) Int. Cl. A62C 37/11

(52) U.S. Cl. CPC A62C 37/11

(57) ABSTRACT

A sprinkler head includes a recess provided in a nozzle-side surface of a deflector a first slit provided on each side of the recess in a width direction thereof and having an open end provided adjacent to an outer edge of the recess; a plurality of second slits having open ends provided along the outer edge of the deflector, on an opposite side of the first slit in a width direction thereof from the recess, and closed ends provided away from an outer edge of the valve cap; and a plurality of third slits having open ends provided along the outer edge of the deflector, on an opposite side of the second slits in a width direction thereof from the first slit, and closed ends provided further away from the outer edge of the valve cap than are the closed ends of the second slits.

### TECHNICAL FIELD

The present disclosure relates to a fire extinguishing sprinkler head.

### BACKGROUND ART

A sprinkler head automatically operates to spray water in the case of fire. A nozzle is normally closed by a valve. The valve is supported at the lower end of a body by a heat-sensitive operation part. The heat-sensitive operation part is disassembled and operated when a heat-sensitive element incorporated in the heat-sensitive operation part is operated by the heat of fire. The valve is pressed toward the nozzle by the heat-sensitive operation part. The nozzle is opened when the valve moves away from the nozzle. The water discharged from the nozzle collides with a plate-like deflector disposed in the extension direction of the axis of the nozzle and is scattered in all directions to extinguish fire.

An example of the sprinkler head described above is a flush-type sprinkler head. The flush-type sprinkler head is installed such that a body connected to a water supply pipe is embedded in the ceiling, so that only the lower part of the heat-sensitive operation part protrudes from the ceiling surface into the room. The deflector is housed inside the sprinkler head. The deflector moves into the room by a certain distance after the heat-sensitive operation part is disassembled and operated in the case of fire. The deflector is connected to the body by a plurality of pins.

The water discharged from the nozzle collides with the center side of the deflector, flows radially, and is scattered from the edge of the deflector. At this time, around the pins, the water flowing from the center toward the edge of the deflector is blocked by the pins. Thus, the amount of water sprayed in the directions in which the pins are disposed tends to be small.

Hence, the fewer the pins, the more uniform the water spray pattern can be. However, reducing the pins requires increasing the thickness of the pins to ensure a strength that allows them to withstand the force of the water flow. Hence, the thicker the pins, the larger the influence on the water flow, making it difficult to obtain a uniform water spray pattern.

PTL 1 discloses a means for solving the above problem, in which recesses are provided at portions around the pins in the deflector, and bottoms of the recess are formed to the outer circumference of the deflector. The sprinkler head in PTL 1 guides the flow of water into the recesses to secure a certain amount of water flowing in the directions in which the pins are disposed.

### CITATION LIST

### Patent Literature

PTL 1: Japanese Unexamined Utility Model Registration Application Publication No. 6-39030

### SUMMARY OF INVENTION

### Technical Problem

However, to enhance the fire suppression effect, it is desirable not only to secure a certain amount of water flowing in the directions in which the pins are disposed, but also to increase the amount of water sprayed in all directions by the sprinkler head.

An object of the present disclosure is to provide a sprinkler head in which not only the amount of water sprayed by the sprinkler head in the directions in which the pins supporting the deflector are disposed is increased, but also the amount of water sprayed in all directions is increased.

### Solution to Problem

To achieve the above object, the present disclosure provides a following sprinkler head. An aspect of the present disclosure provides a sprinkler head including: a body having a nozzle that discharges a fire extinguishing liquid; a valve cap that closes the nozzle; a heat-sensitive operation part that maintains a closed state of the valve cap with respect to the nozzle and removes the closed state when disassembled and operated; a disc-shaped deflector that scatters the fire extinguishing liquid discharged from the nozzle outward in a direction intersecting an axis of the nozzle; and a strut that supports the deflector. The sprinkler head includes: a recess provided in a nozzle-side surface of the deflector and formed from a portion around the strut toward an outer edge of the deflector so as to be recessed into the nozzle-side surface of the deflector; a first slit provided on each side of the recess in a width direction thereof and having an open end provided adjacent to an outer edge of the recess; a plurality of second slits having open ends provided along the outer edge of the deflector, on an opposite side of the first slit in a width direction thereof from the recess, and closed ends provided away from an outer edge of the valve cap; and a plurality of third slits having open ends provided along the outer edge of the deflector, on an opposite side of the second slits in a width direction thereof from the first slit, and closed ends provided further away from the outer edge of the valve cap than are the closed ends of the second slits.

According to the aspect of the present disclosure, the water flowing into the recess is regulated, a large amount of water is scattered in a direction perpendicular to the outer edge of the recess, and the water scattered from the first slit is scattered toward the extension of the virtual line. Hence, it is possible to increase the amount of water sprayed in the directions in which the pins are disposed. Furthermore, because the plurality of second slits and the plurality of third slits are additionally provided on the outer edge side of the deflector, it is possible to increase the amount of water sprayed in all directions.

### Advantageous Effects of Invention

According to the present disclosure, not only the amount of water sprayed by the sprinkler head in the directions in which the pins supporting the deflector are disposed is increased, but also the amount of water sprayed in all directions is increased.

### BRIEF DESCRIPTION OF DRAWINGS

FIG. 1 is a sectional view of a sprinkler head of the present disclosure.

FIG. 2 is a sectional view taken along line II-II in FIG. 1.

FIG. 3 is a perspective view of a deflector unit.

FIG. 4 is a plan view of a deflector.

FIG. 5 is an enlarged view of a pin (strut) and the vicinity thereof in FIG. 3.

FIG. 6 is an exploded perspective view of a heat-sensitive operation part.

FIGS. 7A and 7B are diagrams for explaining a water spray distribution test of the sprinkler head of the present disclosure.

FIG. 8 is a diagram for explaining a crib fire test of the sprinkler head of the present disclosure.

FIGS. 9A and 9B are diagrams for explaining test results of the crib fire test of the sprinkler head of the present disclosure.

FIGS. 10A and 10B are diagrams for explaining test results of the water spray distribution test of the sprinkler head of the present disclosure.

FIG. 11 is a diagram for explaining another test result of the water spray distribution test of the sprinkler head of the present disclosure.

FIG. 12 shows the sprinkler head of the present disclosure in a state of spraying water.

### DESCRIPTION OF EMBODIMENTS

Hereinbelow, an aspect of the present disclosure will be described in detail. However, the description is not intended to limit the scope of the present disclosure, but should be understood as a description for explaining exemplary embodiments. The following description does not unduly limit the scope of the claims, and all the configurations described in this embodiment are not necessarily essential as solving means.

In the following description, terms indicating directions, such as “up”, “down”, “left”, and “right” are used for convenience of description, and do not limit the method of use or the mode of use. Terms such as “the first” and “the n-th” (n is an integer) following “the first” described in the specification and the claims are used as identification terms for distinguishing different elements, and do not indicate a specific order, superiority, or the like.

The terms used in the following description are solely for the purpose of describing particular embodiments and are not intended to limit the scope of the present disclosure. A component according to the embodiment described in the specification and the claims is intended to include a plurality of the components as well, unless otherwise it is clearly described as one component or a plurality of components in the context.

The term “and/or” is intended to mean and include any one of listed associated items and all possible combinations thereof. The terms “includes”, “including”, “comprises”, and/or “comprising” used in the specification and the claims specify the presence of a feature, an operation, an element, and a step. However, the terms are used as terms that do not preclude the presence or addition of one or more other features, operations, elements, steps, and/or groups thereof.

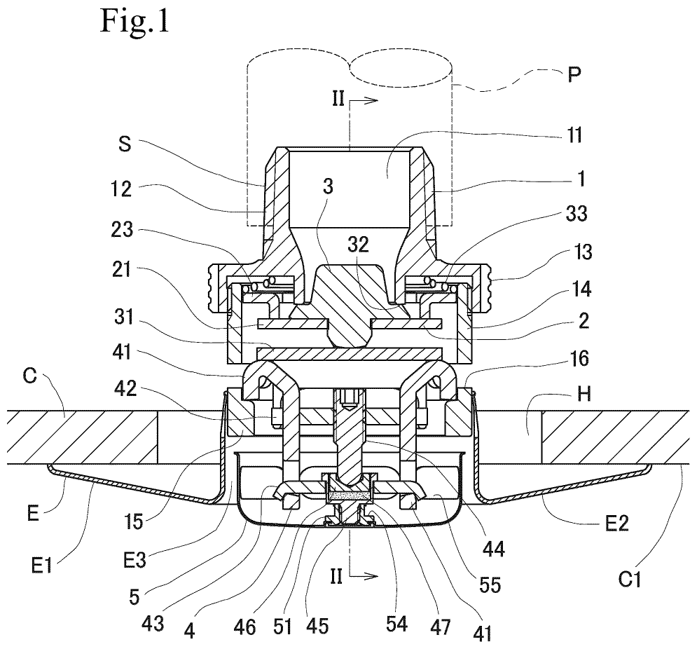

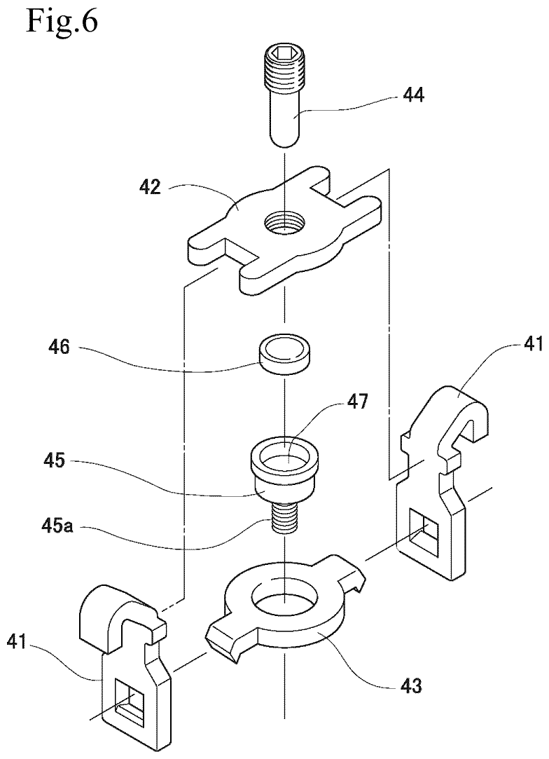

An embodiment of a “sprinkler head” according to the present disclosure will be described with reference to FIGS. 1 to 6. The sprinkler head S has a body 1, a deflector unit 2, a valve cap 3, a heat-sensitive operation part 4, and a heat collector 5. The sprinkler head S according to this embodiment is a flush-type sprinkler head that is installed such that the body 1 connected to a water supply pipe is embedded in the ceiling.

The body 1 is a hollow tube, and the inside thereof constitutes a nozzle 11. The nozzle 11 has a tubular shape and extends in a tube axis direction (height direction, vertical direction) between one end and the other end of the body 1. In the specification and the claims, the “axial direction” of the nozzle 11 is also referred to as a “tube axis direction”. A male screw 12 to be connected to a water supply pipe P is provided at one end of the body 1. The body 1 has a flange 13 extending outward at the other end thereof, and a tubular frame 14 is screwed to the flange 13.

The frame 14 is disposed on the outer circumferential side of the outlet end of the nozzle 11. A step 15 extending radially inward is disposed at the lower end (the end of the frame 14 on the side opposite from the side connected to the flange 13) of the inside of the frame 14. Levers 41 of the heat-sensitive operation part 4 (described below) are engaged with the step 15.

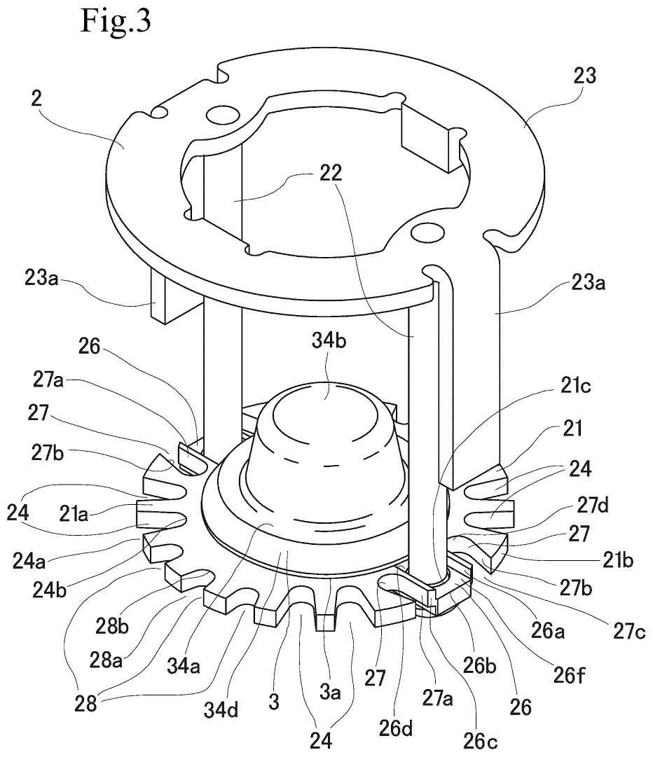

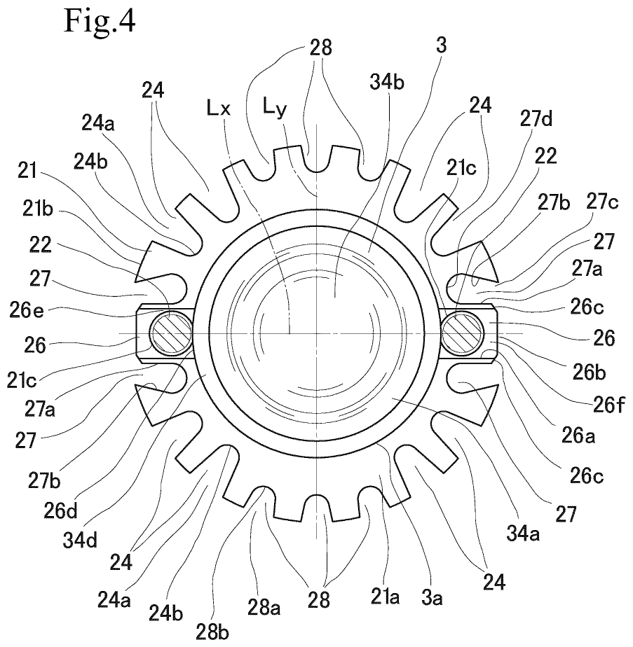

The deflector unit 2 in FIG. 3 includes a deflector 21, pins 22 serving as struts, and a guide ring 23. The deflector unit 2 is accommodated in the frame 14. The deflector 21 is disc-shaped and has a plurality of slits 24, 27, and 28 in the circumference (outer edge) thereof. As shown in FIG. 4, the slits 24, 27, and 28 are arranged symmetrically with respect to a virtual line Lx passing through the center axes of the pins 22 and the center of the deflector 21.

In this embodiment, the plurality of first slits 27, second slits 24, and third slits 28 having different shapes and sizes are provided along an outer edge 21b of the deflector 21. The first slits 27 are provided on both sides of recesses 26 (described below) in the width direction thereof such that open ends 27c thereof are provided adjacent to outer edges 26b of the recesses 26. The detailed configuration of the first slits 27 will be described below.

As shown in FIG. 4, the second slits 24 are provided on the opposite sides of the first slits 27 from the recesses 26 in the width direction thereof such that open ends 24a thereof extend along the outer edge 21b of the deflector 21. In this embodiment, the second slits 24 are provided in pairs in each of directions from the center of the deflector 21 at angles of 45°, 135°, 225°, and 315° with respect to the virtual line Lx passing through the center axes of the pins 22 and the center of the deflector 21. In the second slits 24, closed ends 24b are provided away from an outer edge 3a of the valve cap 3, and the depth of the slits is small. In this embodiment, the number of the second slits 24 provided in each of directions from the center of the deflector 21 at angles of 45°, 135°, 225°, and 315° with respect to the virtual line Lx is not limited to two at each direction. Because it is only necessary that a plurality of second slits 24 are provided in each of the above-described directions, three or more second slits 24 may be provided in each of the directions.

In this specification, the directions from the center of the deflector 21 at angles of 45°, 135°, 225°, and 315° with respect to the virtual line Lx may be referred to as the “the direction at an angle of 45°”.

The third slits 28 are provided on the opposite sides of the second slits 24 from the first slits 27 in the width direction thereof such that open ends 28a thereof extend along the outer edge 21b of the deflector 21. In this embodiment, the third slits 28 are provided in groups of three in each of directions from the center of the deflector 21 at angles of 72° to 108° and 252° to 288° with respect to the virtual line Lx. In the third slits 28, closed ends 28b are provided away from the outer edge 3a of the valve cap 3, and the depth of the slits is smaller than the second slits 24. In this embodiment, the number of the third slits 28 is not limited to three in each of directions from the center of the deflector 21 at angles of 72° to 108° and 252° to 288° with respect to the virtual line Lx. Because it is only necessary that a plurality of third slits 28 are provided in each of the above-described directions, two or four or more third slits 28 may be provided in each of the directions. In this specification, the directions from the center of the deflector 21 at angles of 72° to 108° and 252° to 288° with respect to the virtual line Lx may be referred to as “the direction at an angle of 72°”.

The second slits 24 and the third slits 28 each have a shape (tapered shape) in which the width thereof increases from the center side of the deflector 21 toward the open ends 24a or 28a on the outer circumferential side (outer edge side). The angle of the tapered shape is preferably 20° to 30° from the standpoint of the water spray performance. Basically, the water spray amount can be increased by increasing the angle of the tapered shape of the second slits 24 and the third slits 28. However, if the angle of the tapered shape is increased, the tips of the deflector 21 are sharpened, which may lower the durability of a mold when the deflectors 21 are mass-produced. Hence, in this embodiment, the angle of the tapered shape, which is the maximum taper angle with fixed depths of the second slits 24 and the third slits 28, is set to 25°.

The deflector 21 has, in the center thereof, a hole (center hole) extending therethrough in the thickness direction (the tube axis direction of the body 1), and the valve cap 3 is rotatably disposed in the hole. The closed ends 24b and 28b of the second slits 24 and the third slits 28 on the center side of the deflector 21 are provided away from the outer edge 3a of the valve cap 3. In this embodiment, the closed ends 28b of the third slits 28 are provided further away from the outer edge 3a of the valve cap 3 than are the closed ends of the second slits 24. In other words, the third slits 28 have a smaller depth than the second slits 24.

There are a plurality of pins 22 disposed between the deflector 21 and the guide ring 23. The sprinkler head S according to this embodiment has two pins 22. The pins 22 are inserted through holes 21C (pin insertion holes) formed in the vicinity of the circumference of the deflector 21 so as to extend through the deflector 21 in the thickness direction thereof (the tube axis direction of the body 1). The pins 22 are disposed adjacent to the outer edge 3a of the valve cap 3 provided on the deflector 21. One ends (guide ring side ends) of the pins 22 are fixedly connected to the annular guide ring 23, and another ends (deflector side ends) of the pins 22 constitute flanges 25. With this structure, the deflector 21 is slidably held between the guide ring 23 and the flanges 25.

A flat surface 21a of the deflector 21 on the nozzle 11 side is provided with the recesses 26 extending from the portions around the holes 21C, through which the pins 22 are inserted, to the outer edge 21b of the deflector 21, so as to be recessed into the flat surface 21a of the deflector 21 on the nozzle 11 side toward the heat-sensitive operation part 4 side. Steps between bottom surfaces 26f of the recesses 26 and the flat surface 21a, which is a general surface, of the deflector 21, constitute side walls 26a. The water (fire extinguishing liquid) flowing into the recesses 26 is regulated by the side walls 26a and is scattered from the outer edges 26b of the recesses 26. The steps in the recesses 26 have a function of guiding the fire extinguishing liquid discharged from the nozzle 11 to the recesses 26. In this embodiment, an example case in which the bottom surfaces 26f of the recesses 26 have a shape protruding downward, which is obtained by depressing the flat surface 21a of the deflector 21 has been described. However, the recesses may be formed by crushing a metal material forming the deflector 21. In that case, the thickness of the recesses (the bottom surface portions of the recesses) in the thickness direction of the deflector 21 is thinner than the thickness of the portions around the recesses.

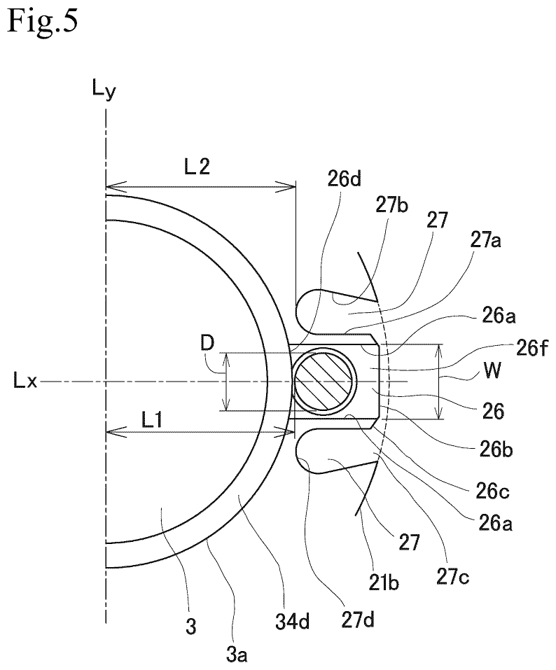

The outer edges 26b of the recesses 26 are located inside a virtual outer circumference of the deflector 21, indicated by a broken line in FIG. 5, and are formed in a linear shape. Hence, a large amount of water is scattered in directions perpendicular to the linear outer edges 26b. Furthermore, because the linear outer edges 26b of the recesses 26 are located inside the virtual outer circumference of the deflector 21, the throw of water scattered from the recesses 26 is shorter than the throw of water scattered from the outer edge of the deflector 21. Hence, it is possible to spray water over an area at a short distance from the place where the sprinkler head S is installed. Meanwhile, inner edges 26d of the recesses 26 are arranged so as to overlap the outer edge 3a of the valve cap 3. In this embodiment, the outer edges 26b of the recesses 26 are formed in a linear shape. However, the shape of the outer edges 26b is not limited to a linear shape as long as the outer edges 26b are located inside the virtual outer circumference of the deflector 21.

As shown in FIG. 5, the width W of the recesses 26 is preferably 1.2 to 1.5 times the diameter D of the pins 22. In this embodiment, the width W of the recesses 26 is about 1.3 times the diameter D of the pins 22. With this structure, narrowed portions 26e are formed between the pins 22 and the side walls 26a of the recesses 26. Hence, the flow velocity of the water passing through the narrowed portions 26e increases.

The first slits 27 are provided on both sides of each recess 26 in the width direction. As shown in FIG. 5, the first slits 27 are provided such that the open ends 27c thereof are adjacent to the outer edge 26b of the recess 26. The first slits 27 each have a first side 27a located on the pin 22 side and a second side 27b facing the first side 27a. The first side 27a is formed along the side wall 26a of the adjacent recess 26 and is formed parallel to the virtual line Lx. The second side 27b is formed so as to be closer to the first side 27a on the open end side of the first slit 27 than on the closed end side thereof. In other words, the second side 27b is inclined with respect to the virtual line Lx and is formed so as to intersect the virtual line Lx when the second side 27b is extended in the direction of the open end 27c of the first slit 27.

Specifically, in each of the first slits 27, the second side 27b is inclined with respect to the virtual line Lx so as to intersect the virtual line Lx when the second side 27b is extended in the direction of the open end 27c of the first slit 27. Hence, the slit width of the first slits 27 decreases toward the outer edge of the deflector 21, making it possible to increase the flow velocity of the water flowing therein and scatter the water from the first slits 27 in the directions in which the pins 22 are disposed, toward the extensions of the virtual line Lx. In this embodiment, because the first slits 27 are provided on both sides of the recesses 26 in the width direction, the amount of water sprayed in the directions in which the pins 22 are disposed can be increased.

The water flowing into the first slits 27 flows along the second sides 27b. Then, the water flows in the direction normal to a straight line connecting the open ends 27c, and thus flows toward the extensions of the virtual line Lx behind the pins 22. Furthermore, by cutting the corners between the outer edges 26b of the recesses 26 and the first slits 27 at an angle to form slopes 26c, the water flowing through the first slits 27 becomes more likely to flow in the direction of the virtual line Lx by the slopes 26c.

As shown in FIG. 5, the closed ends 27d of the first slits 27 are disposed away from the outer edge 3a of the valve cap 3. More specifically, the length L1 between a perpendicular virtual line Ly, which is obtained by rotating the virtual line Lx by 90° about the center of the deflector 21, and the outer circumference of a pin 22 is substantially equal to the length L2 between the perpendicular virtual line Ly and the closed end of a first slit 27. When the first slits 27 are shallow, and the relationship between the lengths L1 and L2 is L1<L2, the water is sprayed over positions far from the head, on the back of the pins 22. In contrast, when the first slits 27 are deep, and the relationship between the lengths L1 and L2 is L1<L2, the water is sprayed over positions too close to the head, on the back of the pins 22. Hence, in this embodiment, the lengths L1 and L2 are set substantially equal to each other, i.e., L1≈L2, so that water can be easily sprayed over desired suitable positions at an appropriate distance from the head, on the back of the pins 22.

As described above, the first ends of the pins 22 are fixedly connected to the guide ring 23. The outer diameter of the guide ring 23 is smaller than the inner diameter of the frame 14 and is larger than the inner diameter of the step 15. Hence, the guide ring 23 is configured to be engaged with the step 15 after the guide ring 23 is detached as a result of the operation of the heat-sensitive operation part 4.

Arms 23a are provided on the outer edge of the guide ring 23. The arms 23a are provided parallel to the pins 22 and are arranged adjacent to the pins 22. More specifically, the arms 23a are arranged on a virtual plane (not shown) in which the virtual line Lx and the axis of the nozzle 11 intersect with each other. The length of the arms 23a is shorter than the length of the pins 22. The arms 23a are accommodated in grooves 15a formed in the step 15 of the frame 14. The grooves 15a are parallel to the axis of the nozzle 11 and serve as a guide when the guide ring 23 slides in the frame 14.

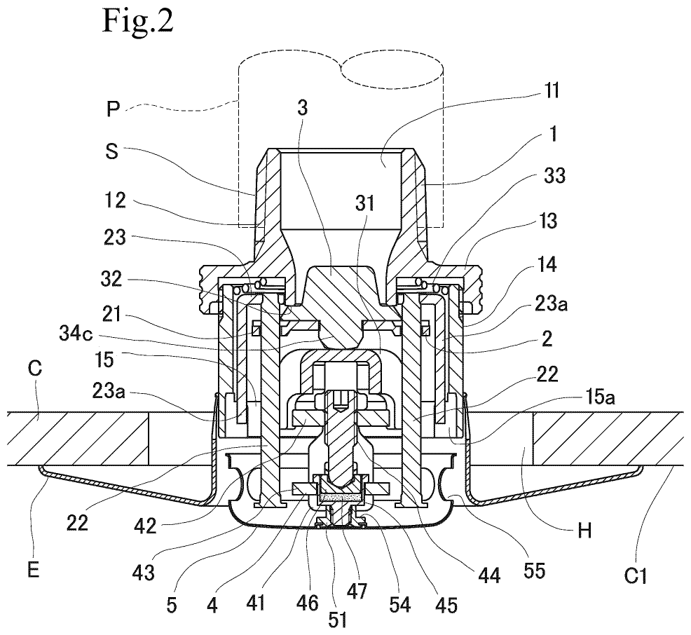

When the nozzle 11 is open to discharge water, the grooves 15a hold the side surfaces of the arms 23a. This keeps the flat surface 21a of the deflector 21 perpendicular to the center axis of the nozzle 11, thus preventing the deflector 21 from swinging, even when the flow of water is unstable. Furthermore, because the arms 23a are accommodated in the grooves 15a, the guide ring 23 and the deflector 21 are prevented from moving in the circumferential direction. As shown in FIG. 2, the grooves 15a are provided at positions rotated by 90° about the axis of the nozzle 11, from the positions where the levers 41 are engaged with the step 15.

The valve cap 3 is formed in a disk shape having a projection on the nozzle 11 side. A plate-like saddle 31 is provided between the valve cap 3 and the levers 41. The valve cap 3 closes the outlet end of the nozzle 11 as a result of the levers 41 engaged with the step 15 being pressed via the saddle 31 and held at the outlet position of the nozzle 11.

A seal member 32 is provided between the valve cap 3 and the outlet end of the nozzle 11. The seal member 32 is made of, for example, a fluororesin. Although the seal member 32 is provided at the outlet end of the nozzle 11 in this embodiment, the seal member 32 may be provided on the valve cap 3. In this state, the deflector 21 provided in such a manner that the valve cap 3 is placed thereon is disposed in the frame 14, at a position close to the guide ring 23. A biased spring 33 is provided between the guide ring 23 and the flange 13. When the heat-sensitive operation part 4 is operated, the spring 33 facilitates movement of the guide ring 23, the deflector 21, and the valve cap 3 to the outside of the frame 14. The load of the spring 33 is lower than the load with which the valve cap 3 is pressed against the outlet end of the nozzle 11.

As shown in FIGS. 2 and 3, the valve cap 3 has an annular flat portion 34a to be in contact with the outlet end of the nozzle 11, an inner protrusion 34b provided inside the flat portion 34a and protruding toward the inside of the nozzle 11, and an outer protrusion 34c protruding in the direction opposite to the direction in which the inner protrusion 34b protrudes. The flat portion 34a has, at the outer edge thereof, a slope 34d formed so as to extend from the surface on the inner protrusion 34b side toward the outer edge. The shapes of the flat portion 34a, the inner protrusion 34b, and the slope 34d influence on the water spray pattern because the water discharged from the nozzle 11 when the sprinkler head is operated collides with these portions and flows over the surfaces of these portions.

The outer edge 3a of the valve cap 3 is disposed so as to overlap the inner edge 26d of the recess 26. Thus, the water flows down the slope 34d of the valve cap 3 and flows into the recess 26 without reducing its momentum. The outer edge 3a of the valve cap 3 is disposed away from the closed ends 24b of the second slits 24 and the closed ends 28b of the third slits 28.

In this embodiment, the pins 22 are disposed adjacent to the outer edge 3a of the valve cap 3. More specifically, because the deflector 21 slides along the pins 22 when the heat-sensitive operation part 4 is operated, the outer edge 3a of the valve cap 3 and the pins 22 are disposed close to each other with a slight clearance between the valve cap 3 and the pins 22. By arranging the pins 22 and the outer edge 3a of the valve cap 3 close to each other in this way, the water discharged from the nozzle 11 flows directly from the valve cap 3 into the recesses 26 in which the pins 22 are disposed. Hence, the water is scattered from the outer edges 26b of the recesses 26 while maintaining its momentum.

The heat-sensitive operation part 4 shown in FIGS. 1, 2, and 6 includes a pair of levers 41, a support plate 42, a balancer 43, a set screw 44, a cylinder 45, a plunger 46, and a fusible alloy 47. The known parts of the configuration of the heat-sensitive operation part 4 are described in, for example, Japanese Unexamined Patent Application Publication No. 2005-27929.

The cylinder 45 is formed in a bottomed cylindrical shape, and a male screw protrudes from the bottom surface thereof. The cylinder 45 is filled with the fusible alloy 47, and the plunger 46 is placed on the fusible alloy 47, that is, on the side opposite from the bottom surface of the cylinder 45. These members constitute the heat-sensitive element of the heat-sensitive operation part 4. As shown in FIGS. 1 and 2, a heat collector 5 is connected to the male screw. Thus, the heat collector 5 is held by the body 1 so as to protrude from the lower end of the body 1.

The heat collector 5 is formed in a bowl shape with a nut 51 attached to the center thereof. The nut 51 is screwed with the male screw 45a of the cylinder 45. The nut 51 is formed to have a large diameter at the end thereof on the heat collector 5 side and a small diameter at the end thereof on the cylinder 45 side. With this structure, the nut 51 has a step 54 in the middle thereof. An adhesive poured into a screw joint portion between the nut 51 and the male screw 45a, formed after the nut 51 is connected to the cylinder 45, is cured.

The nut 51 is in direct contact with the bottom surface of the cylinder 45 at the end on thereof the heat collector 5 side. The end of the nut 51 on the heat collector 5 side has a larger diameter than the end of the nut 51 on the cylinder 45 side. Hence, the contact area between the heat collector 5 and the nut 51 is large. Thus, stable bonding strength between the heat collector 5 and the nut 51 is obtained. Furthermore, because the contact area between the heat collector 5 and the nut 51 is larger than that on the cylinder side end, the heat absorbed by the heat collector 5 can be efficiently transferred to the nut 51.

The outer diameter of the end of the nut 51 is less than or equal to the diameter of the bottom surface of the cylinder 45. More preferably, the outer diameter of the end of the nut 51 is less than or equal to the inner diameter of the cylinder 45. With this configuration, the heat absorbed by the heat collector 5 is transmitted to the fusible alloy 47 via the nut 51 and the bottom surface of the cylinder 45, without passing through, for example, the side surface of the cylinder 45 and the loss during the heat transmission is suppressed.

The heat collector 5 has a plurality of openings 55 in a side surface thereof. The openings 55 have a uniform length and are arranged at equal intervals over the entire side surface of the heat collector 5. In the embodiment shown in FIG. 1, six openings 55 are provided. The number of openings 55 is larger than the number of levers 41. By making the openings 55 have a certain size, it is possible to increase the efficiency of passage of an air current to the heat collector 5. More specifically, the height of the openings 55 is 2-5 mm, and the width of the openings 55 is 8-12 mm. With this configuration, the air current heated by the fire flows into the heat collector 5 through the openings 55, allowing the heat collector 5 to absorb heat also from the inside thereof.

An escutcheon E includes a dish part E1 that covers a hole H between a ceiling C and the sprinkler head S, and a tubular part E2 extending from the inner edge of the dish part E1 and engaged with the frame 14. The dish part E1 is configured such that the outer peripheral edge extending outward from the lower end of the tubular part E2 can contact a ceiling surface C1.

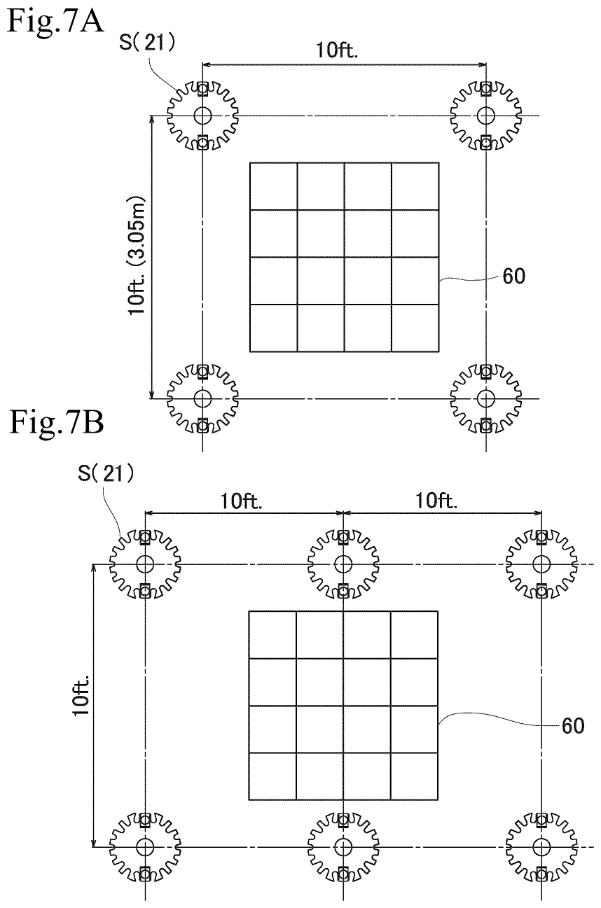

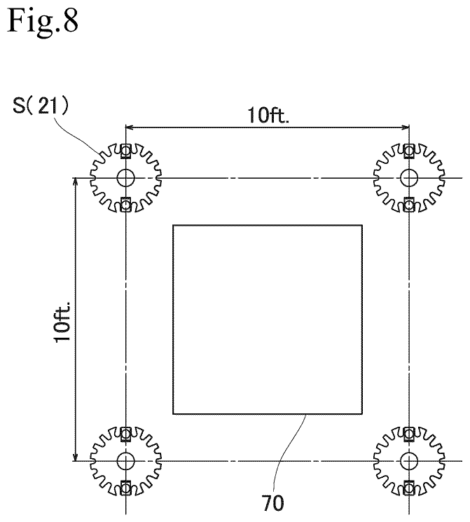

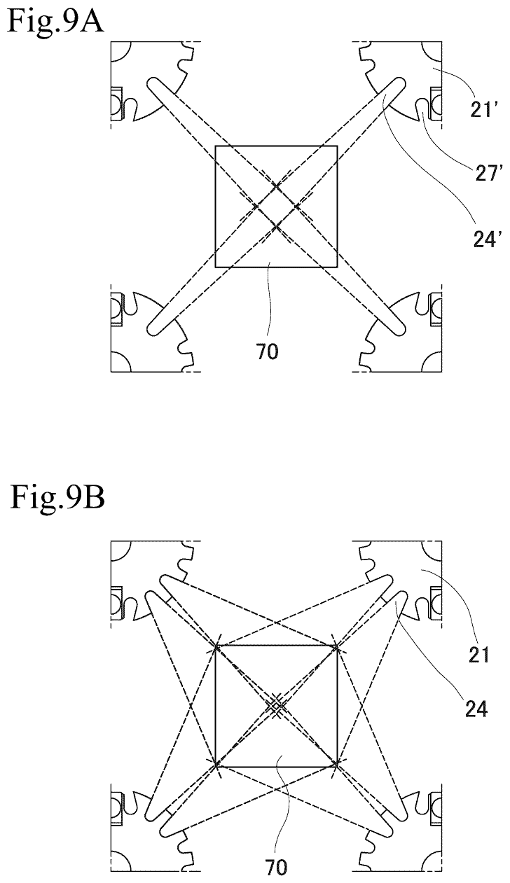

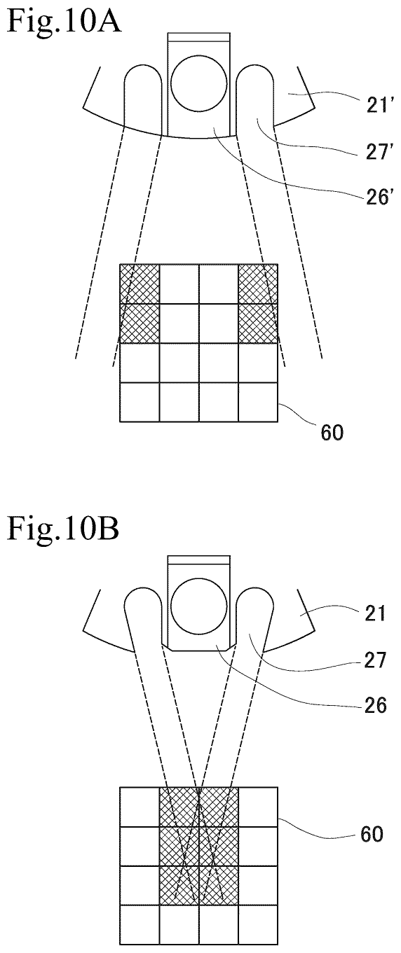

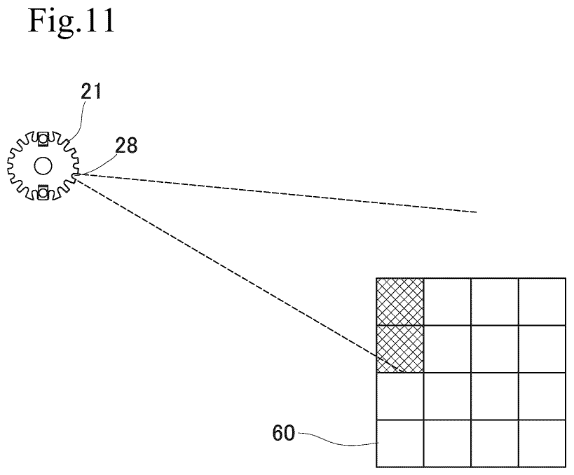

Next, performance tests and test results of the sprinkler head of the present disclosure will be described with reference to the drawings. FIGS. 7A and 7B are diagrams for explaining a water spray distribution test of the sprinkler head of the present disclosure. FIG. 8 is a diagram for explaining a crib fire test of the sprinkler head of the present disclosure. FIGS. 9A and 9B are diagrams for explaining the test results of the crib fire test of the sprinkler head of the present disclosure. FIGS. 10A and 10B are diagrams for explaining the test results of the water spray distribution test of the sprinkler head of the present disclosure. FIG. 11 is a diagram for explaining another test result of the water spray distribution test of the sprinkler head of the present disclosure. In FIGS. 9A, 9B, 10A, 10B, and 11, the water spray area from each slit is indicated by broken lines.

A water collection distribution test and a crib fire test were performed to test the performance of the sprinkler head S of the present disclosure. In the water collection distribution test, water was actually sprayed from the sprinkler head S over a water collection container unit 60, consisting of a total of 16 one-foot-square water collection containers arranged in four rows and four columns, and the average amount of water collected per water collection container was measured. More specifically, the water collection test was performed for each of the case where four sprinkler heads S were arranged at 10-feet intervals on the outside of the four corners of the water collection container unit 60, as shown in FIG. 7A, and the case where six sprinkler heads S were arranged at 10-feet intervals on the outside of the four corners of the water collection container unit 60 and at intermediate positions, in the lateral direction, between the four corners, as shown in FIG. 7B. Meanwhile, in the crib fire test, as shown in FIG. 8, a four-feet-square crib 70 was burnt, and fire extinguishing operation was actually performed by four sprinkler heads S arranged at 10-feet intervals on the outside of the four corners of the crib 70 to check the fire suppression effect.

As shown in FIG. 9A, deflectors 21′ according to a comparative example in the crib fire test are each provided with only one slit 24′ having a small angle of the tapered shape and a large depth in the direction at an angle of 45°. Hence, the water spray areas from the slits 24′ provided in the direction at an angle of 45° were limited to the areas on the diagonal lines of the crib 70 and the vicinity thereof. Thus, fire suppression by spraying of water over the entire area of the crib 70 was insufficient. Furthermore, In the comparative example, because the singly provided slit 24′ had a large depth, a larger amount of water flowed into the slit 24′. This reduced the amount of water sprayed to a first slit 27′, failing to secure a sufficient amount of water sprayed in the directions of the pins. The test result of the crib fire test with the comparative example shows that it is necessary to enhance the fire suppression effect in the entire area of the crib 70.

In contrast, in the deflector 21 of this embodiment, as shown in FIG. 9B, two second slits 24 having a small depth and a wider tapered shape than the slit 24′ of the comparative example were provided in the direction at an angle of 45°. This increases the throw of the water sprayed from the second slits 24 and makes it possible to spray water over a wider area from the direction at an angle of 45° with respect to the deflector 21.

In the deflector 21 of this embodiment, because the second slits 24 have a smaller depth than the slit 24′ of the comparative example, the size of each slit is small. This reduces the amount of water flowing into each second slit 24, and hence, the amount of water sprayed from the first slits 27 does not decrease. Thus, it is possible to secure a sufficient amount of water sprayed in the directions of the pins.

Furthermore, although each second slit 24 is smaller than the slit 24′ of the comparative example, the second slits 24 are provided in a pair in the direction at an angle of 45°. Hence, it is possible to secure a sufficient amount of water sprayed over a wider area. This shows that the provision of a pair of second slits 24 having a small depth and a tapered shape in the direction at an angle of 45° with respect to the deflector 21 not only increases the amount of water sprayed in the direction at an angle of 45° with respect to the deflector 21, but also increases the water spray areas, making it possible to obtain fire suppression effect over substantially the entire surfaces of the crib 70.

Meanwhile, referring to the test results of the water collection distribution tests, in the deflector 21′ of the comparative example, the first slits 27′ arranged parallel to the recess 26′ are substantially parallel and have a small angle of the tapered shape. Hence, as shown in FIG. 10A, the average amount of water collected by the water collection containers disposed at the near corners of the water collection container unit 60 was large, whereas the average amount of water collected by the water collection containers on the center side of the water collection container unit 60 was small. The test results of the water collection distribution test show that, with a configuration in which the first slits 27 arranged parallel to the recess 26′ are substantially parallel, a sufficient amount of water to be sprayed in the directions of the pins 22 needs to be secured.

In contrast, in the deflector 21 of this embodiment, as shown in FIG. 10B, the width of the first slits 27 decreases from the center side toward the outer edge side of the deflector 21. Hence, the water sprayed from the first slits 27 was directed to the center of the water collection container unit 60, increasing the average amount of water collected by the water collection containers provided on the center side of the water collection container unit 60. This shows that the amount of water sprayed in the directions of the pins 22, including the rear side of the pins 22, can be increased by providing the first slits 27, whose slit width decreases from the center side toward the outer edge side of the deflector 21, on both sides of the recess 26.

Furthermore, referring to another test result of the water spray distribution test, as shown in FIG. 11, in this embodiment, three third slits 28 having a small depth and a tapered shape are provided in the direction at an angle of 72° to 108° from the center of the deflector 21. Hence, the average amount of water collected by the water collection containers on the near side among the four corners of the water collection container unit 60 was increased. This shows that the provision of three shallow third slits 28 having a tapered shape in the direction at an angle of 72° to 108° from the center of the deflector 21 increases the amount of water sprayed to the water collection containers at the four corners of the water collection container unit 60. Furthermore, because the third slits 28 have a smaller depth than the second slits 24, the water can be sprayed to an even farther position, increasing the water spray area.

Based on the results of these performance tests, in this embodiment, the amount of water sprayed in the directions of the pins of the deflector 21 is increased by providing the recesses 26 in the directions in which the pins 22 of the deflector 21 are disposed and the first slits 27 on both sides of the recesses 26. Furthermore, by providing multiple second slits 24 having a tapered shape in which the width thereof increases toward the outer edge side in the direction at an angle of 45° with respect to the deflector 21, it is possible not only to increase the amount of water sprayed from the direction at an angle of 45° with respect to the deflector 21, but also to increase the water spray area. Furthermore, by providing multiple third slits 28 having a tapered shape in which the width thereof increases toward the outer edge side in the direction at an angle of 72° (the direction at an angle of 72° to 108°) with respect to the deflector 21, it is possible not only to increase the throw of the water sprayed from the direction at an angle of 72° with respect to the deflector 21, but also to increase the amount of water sprayed to the four corners of a fire extinguishing target. That is, in this embodiment, by providing the recesses 26, the first slits 27, the second slits 24, and the third slits 28 in the deflector 21, it is possible not only to increase the amount of water sprayed in the directions of the pins 22 of the deflector 21, but also to increase the amount of water sprayed in all directions of the sprinkler head S. Thus, the fire suppression effect is increased.

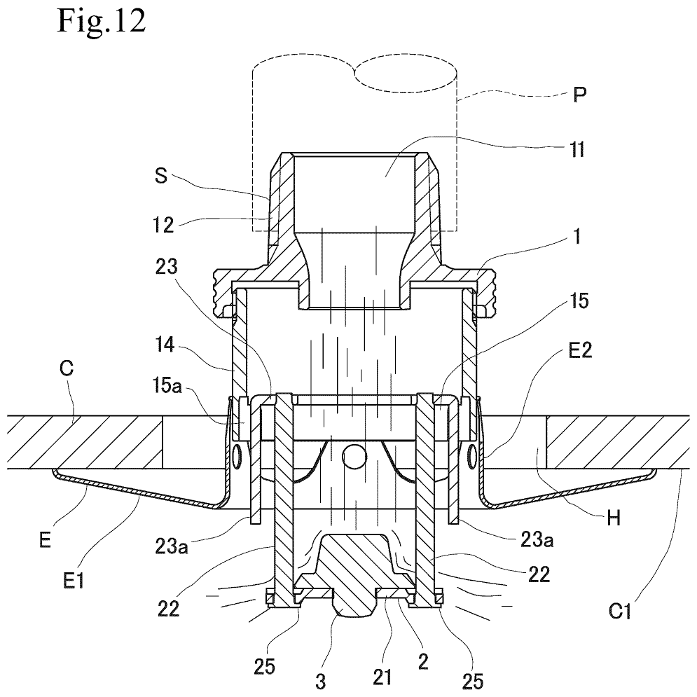

Next, an operation process of the sprinkler head S according to the embodiment of the present disclosure in the case of fire will be described with reference to the drawings. FIG. 12 shows the sprinkler head of the present disclosure in a state of spraying water.

As shown in FIG. 1 described above, the sprinkler head S is installed in a state in which the body 1 is connected to the water supply pipe P by a screw and the heat collector 5 is exposed indoors from the ceiling C. The ceiling C has the hole H through which the sprinkler head S can be inserted to the indoor side, and the escutcheon E is disposed to cover the hole H.

When a fire occurs, the air in the room is warmed by the heat of the fire, an ascending air current is generated, and the warmed air accumulates under the ceiling C. The air driven by the ascending air current flows along the dish part E1 of the escutcheon E and flows into a gap E3 located between the tubular part E2 and the heat collector 5. Furthermore, the air current passes through the openings 55 and reaches the inside of the heat collector 5. The heat of the air current is absorbed from the surfaces of the heat collector 5, the nut 51, and the cylinder 45 and is transmitted to the fusible alloy 47, facilitating melting of the fusible alloy 47.

Once the fusible alloy 47 is melted, the plunger 46 moves toward the bottom surface of the cylinder 45, loosening the engagement between the balancer 43 and the levers 41. As a result, the lower ends of the levers 41 rotate and come off from the balancer 43. The levers 41 rotate further and fall off from the step 15 of the frame 14. In addition, the saddle 31 and the valve cap 3 placed on the levers 41 also fall out of the frame 14.

The deflector unit 2, in which the valve cap 3 is incorporated, slides in the frame 14 and moves toward the step 15, by the action of the spring 33, so that the outer edge side of the guide ring 23 is engaged with the step 15. As shown in FIG. 12, the deflector 21 and the valve cap 3 move downward in the figure along the pins 22 to be engaged with the flange 25. As a result, the deflector 21 and the valve cap 3 are suspended from the frame 14 by the pins 22. When the valve cap 3 is separated from the outlet end of the nozzle 11, the water in the water supply pipe P is discharged from the nozzle 11 and collides with the valve cap 3 and the deflector 21.

The water colliding with the valve cap 3 flows on the surface of the valve cap 3, passes through the surface of the deflector 21, and is scattered over the floor. The water flowing around the pins 22 flows into the recesses 26 from the slope 34d on the outer edge 3a side of the valve cap 3 without passing through the surface of the deflector 21. The water flowing into the recesses 26 increases in flow velocity and is regulated by the side walls 26a when passing through the narrowed portions 26e between the pins 22 and the side walls 26a of the recesses 26, and is scattered from the outer edges 26b of the recesses 26. At this time, the water is scattered in the directions perpendicular to the linear outer edges 26b of the recesses 26, and the water is sprayed at a position closer to the sprinkler head S than the water scattered from the outer edge 21b of the deflector 21. Furthermore, the water passing through the first slits 27 adjacent to the recesses 26 increases in flow velocity and flows toward the extensions of the virtual line Lx, thus increasing the amount of water sprayed on the back of the pins 22.

As described above, in this embodiment, the recesses 26 are provided in the deflector 21, from portions around the pins 22 toward the outer edge 21b, and the first slits 27 are provided on both sides of the recesses 26 in the width direction thereof. The thus-configured deflector 21 can increase the amount of water sprayed in the directions in which the pins 22 are disposed. In particular, by reducing the distance between the first slits 27, the angle between the water sprayed from the left side of the pins 22 and the water sprayed from the right side of the pins 22 is decreased, increasing the amount of water sprayed in the directions of the pins 22. Hence, in this embodiment, the width of the recesses 26 is reduced as much as possible, so that the first slits 27 are close to each other.

Meanwhile, the water flowing from the valve cap 3 to the second slits 24 is sprayed over the floor in an area close to the position where the sprinkler head S is installed. As described above, the second slits 24 have a tapered shape in which the width thereof increases toward the open ends 24a. Hence, the water flowing into the second slits 24 is scattered while spreading along the tapers. This increases the amount of water sprayed over an area close to the sprinkler head S, and moreover, realizes a water spraying pattern in which non-uniformity in the amount of water sprayed is suppressed. Meanwhile, the water scattered from the outer edge 21b of the deflector 21 toward the floor is sprayed over the floor in an area far from the position where the sprinkler head S is installed.

In this way, the water colliding with the deflector 21 is uniformly scattered in all directions over the floor to suppress and extinguish the fire. In particular, in this embodiment, the deflector 21 is provided with the recesses 26 in the directions of the pins 22, the first slits 27 provided on both sides of the recesses 26, and multiple shallow second slits 24 and third slits 28 having a tapered shape in which the width thereof increases toward the outer edge side of the deflector 21. Because this not only increases the amount of water sprayed in the directions in which the pins 22 supporting the deflector 21 are disposed, but also increases the amount of water sprayed in all directions of the sprinkler head S, it is possible to enhance the fire suppression effect.

Hereinbelow, effects of the present disclosure that have not been described above will be described.

The closed ends 24b of the second slits 24 are disposed away from the outer edge 3a of the valve cap 3, and the water flowing on the surface of the valve cap 3 flows from the slope 34d into the slits 24 via the flat surface 21a of the deflector 21. Furthermore, as the height of the inner protrusion 34b of the valve cap 3 increases, the water scattered from the slits 24 is sprayed to a position closer to the sprinkler head S. The height of the top of the inner protrusion 34b from the flat portion 34a is preferably 2 to 3 times the height of the flat portion 34a from the back surface of the flat portion 34a facing the deflector 21, and in this embodiment, the height is set to 2.5 to 2.8 times.

Furthermore, because the outer edges 26b of the recesses 26 are located inside the virtual outer circumference of the deflector 21, the water scattered from the outer edges 26b is sprayed to a position close to the sprinkler head S. By setting the positions of the outer edges 26b closer to the outer periphery of the deflector 21, it is possible to spray the water to a farther position.

By combining the configurations described above, the amount of water sprayed onto a position close to the sprinkler head S is increased.

Although the embodiments of the present disclosure have been described in detail above, it will be readily appreciated by those skilled in the art that various modifications can be made without substantially departing from the new matter and effects of the present disclosure. Hence, all such modifications are included in the scope of the present disclosure.

For example, a term described at least once together with a different term having a broader meaning or the same meaning in the specification or the drawings can be replaced with the different term in any place in the specification or the drawings. Furthermore, the configurations and operations of the sprinkler head and the deflector are not limited to those described in the embodiments of the present disclosure, and various modifications can be made.

### REFERENCE SIGNS LIST

1 BODY
2 DEFLECTOR UNIT
3 VALVE CAP
3a OUTER EDGE (OF VALVE CAP)
4 HEAT-SENSITIVE OPERATION PART
5 HEAT COLLECTOR
11 NOZZLE
14 FRAME
15 STEP
21 DEFLECTOR
21a FLAT SURFACE (NOZZLE SIDE SURFACE)
21b OUTER EDGE (OF DEFLECTOR)
21c HOLE (PIN INSERTION HOLE)
22 PIN (STRUT)
23 GUIDE RING
24 SECOND SLIT
24a OPEN END (OF SECOND SLIT)
24b CLOSED END (OF SECOND SLIT)
26 RECESS
26a SIDE WALL
26b OUTER EDGE (OF RECESS)
26c SLOPE
26d INNER EDGE (OF RECESS)
26e NARROWED PORTION
26f BOTTOM SURFACE
27 FIRST SLIT
27a FIRST SIDE
27b SECOND SIDE
27c OPEN END (OF FIRST SLIT)
27d CLOSED END (OF FIRST SLIT)
28 THIRD SLIT
28a OPEN END (OF THIRD SLIT)
28b CLOSED END (OF THIRD SLIT)
31 SADDLE
32 SEAL MEMBER
33 SPRING
34a FLAT PORTION (OF VALVE CAP)
34b INNER PROTRUSION (OF VALVE CAP)
34c OUTER PROTRUSION (OF VALVE CAP)
34d SLOPE (OF VALVE CAP)
41 LEVER
42 SUPPORT PLATE
43 BALANCER
44 SET SCREW
45 CYLINDER
45a MALE SCREW
46 PLUNGER
47 FUSIBLE ALLOY
51 NUT
54 STEP
55 OPENING
S SPRINKLER HEAD

1. A sprinkler head comprising:
a body having a nozzle that discharges a fire extinguishing liquid;
a valve cap that closes the nozzle;
a heat-sensitive operation part that maintains a closed state of the valve cap with respect to the nozzle and removes the closed state when disassembled and operated;
a disc-shaped deflector that scatters the fire extinguishing liquid discharged from the nozzle outward in a direction intersecting an axis of the nozzle; and
a strut that supports the deflector, wherein the sprinkler head includes:
a recess provided in a nozzle-side surface of the deflector and formed from a portion around the strut toward an outer edge of the deflector so as to be recessed into the nozzle-side surface of the deflector;
a first slit provided on each side of the recess in a width direction thereof and having an open end provided adjacent to an outer edge of the recess;
a plurality of second slits having open ends provided along the outer edge of the deflector, on an opposite side of the first slit in a width direction thereof from the recess, and closed ends provided away from an outer edge of the valve cap; and
a plurality of third slits having open ends provided along the outer edge of the deflector, on an opposite side of the second slits in a width direction thereof from the first slit, and closed ends provided further away from the outer edge of the valve cap than are the closed ends of the second slits.

2. The sprinkler head according to claim 1, wherein
the second slits are provided in pairs in each of directions from a center of the deflector at angles of 45°, 135°, 225°, and 315° with respect to a virtual line passing through a center axis of the strut and the center of the deflector, and
the third slits are provided in groups of three in each of directions from the center of the deflector at angles of 72° to 108° and 252° to 288° with respect to the virtual line.

3. The sprinkler head according to claim 1, wherein the second slits and the third slits have a tapered shape in which a width thereof increases from a center side toward an outer edge side of the deflector.

4. The sprinkler head according to claim 3, wherein an angle of the tapered shape is 20° to 30°.

5. The sprinkler head according to claim 4, wherein the angle of the tapered shape is 25°.

6. The sprinkler head according to claim 1, wherein a width of the first slit decreases from the center side toward the outer edge side of the deflector.

7. The sprinkler head according to claim 1, wherein
the first slit has a first side located on a strut side and a second side facing the first side,
the first side is formed along a side wall of the recess adjacent thereto, and
the second side is formed so as to be closer to the first side on an open end side of the first slit than on a closed end side of the first slit.

8. The sprinkler head according to claim 1, wherein the outer edge of the recess is located inside a virtual outer circumference of the deflector.

9. The sprinkler head according to claim 1, wherein the outer edge of the recess is formed in a linear shape.
